(19) United States
(12) Patent Application Publication
(10) Pub. No.: US 2002/0053981 A1
(43) Pub. Date: May 9, 2002

(54) UNIVERSAL REMOTE CONTROL DEVICE WITH DYNAMIC FUNCTION ALLOCATION FEATURE

(76) Inventor: JOHN M. VAN RYZIN, MADISON, NJ (US)

Correspondence Address: FROMMER LAWRENCE & HAUG, 745 FIFTH AVENUE- 10TH FL., NEW YORK, NY, 10151, US

(21) Appl. No.: 09/017,789

(22) Filed: Feb. 3, 1998

(51) Int. Cl. G08C 19/00; H04B 1/02

(52) U.S. Cl. 340/825.72; 341/176

(57) ABSTRACT

A universal remote control device supports many audio/video (A/V) components and at least as many features on each component as each of the remote control devices uniquely provided by the manufacturers for those A/V components. The user can easily select and activate any of the functions clearly identified on the universal remote control device. PATENT

### BACKGROUND OF THE INVENTION

The present invention is related to wireless data transfer operations and, in particular, to a universal remote control device with functions pertaining to a preselected audio/video device that are dynamically allocated based on a desired mode as selected by the user.

It is well known how difficult it is to control today's multifunctional and very complex audio/video (A/V) components. New technological advances, partially driven by consumer demand for new high-tech equipment, spawn more complicated components than ever, such as a 200 compact disk (CD) changer, integrated television/video cassette recorder (TV/VCR), digital audio tape (DAT) device, digital video disk (DVD) device, etc. Each of these devices performs a myriad of functions that may or may not be important to the user, but are certainly available for him to try. To add convenience for the user, manufacturers provide an individual remote control device for each A/V component. As a result, many users have an array of remote control devices to operate a “livingroom wall” of A/V equipment. The act of juggling this multitude of remote control devices becomes no longer the convenience as originally intended by the manufacturers but a nuisance to many users.

Universal remote control devices allow the user to simplify “the juggling act” of multiple remote control devices by combining the functions of several A/V components into a single unit. However, since conventional remote control devices offer only limited space on their surfaces, all of the buttons (switches) located on the remote control device are cryptically labeled. Simply looking at the remote control device (unit) is not sufficient to recognize what the activation of the button entails. Trial and error method of activating a function to find out what it does may not only be frustrating but also perilous as the user may accidentally erase, delete, etc. some information in a storage medium and/or stop the operation of the device without knowing how to return to its normal operation. This “experimentation” may occur at a very inopportune moment causing further frustration and requiring the user to study the operations manual of the A/V component or to abort its operation.

In addition, conventional remote control devices support only a limited number of functions for the various A/V components. As stated hereinabove, the conventional universal remote control device has limited surface space and is designed to accommodate the most important (basic) functions of the A/V components which it is designed to control. Thus, the user has to either give up those additional features of the A/V components or resort to carrying the individual remote control devices that are provided by the manufacturers, thereby defeating the purpose of the universal remote control device.

A need therefore exists for a system and method for overcoming the above disadvantages.

### OBJECTS OF THE INVENTION

It is an object of the present invention to provide a universal remote control device for controlling audio/video components.

It is another object of the present invention to provide a universal remote control device for supporting all of the features/functions available in each audio/video component.

It is a further object of the present invention to provide a universal remote control device for adaptively controlling the functions of the audio/video components.

### SUMMARY OF THE INVENTION

These and other objects, features and advantages are accomplished by a universal remote control device for wirelessly controlling a number of audio/video devices. The universal remote control device comprises a switch for selecting one of the audio/video devices; a memory for storing data defining a plurality of functions performed by the audio/video devices; a programmable controller for accessing from the memory a set of functions corresponding to the selected audio/video device in response to the switch; a display for displaying a first subset of the accessed set of functions such that each of the displayed functions is available to be performed by the selected audio/video device; and a function mode switch for selecting a second subset of the accessed set of functions such that the display displays the second subset available to be performed by the selected audio/video device.

### BRIEF DESCRIPTION OF THE DRAWINGS

The above-mentioned as well as additional objects, features and advantages of the present invention will become readily apparent from the following detailed description thereof which is to be read in conjunction with the accompanying drawings, in which:

FIGS. 1a and 1b are block diagrams of a universal remote control device for remotely controlling audio/video equipment in accordance with the present invention;

FIG. 2 is a block diagram of the display in the universal remote control device of FIGS. 1a and 1b in accordance with one aspect thereof; and

FIG. 3 representatively illustrates various devices and modes corresponding to each device with the functions performed in each mode.

In all Figures, like reference numerals represent the same or identical components of the present invention.

### DETAILED DESCRIPTION OF THE PREFERRED EMBODIMENTS

As a general overview, the present invention provides a universal remote control device that supports many A/V components and at least as many features on each component as each of the remote control devices uniquely provided by the manufacturers for those A/V components. The user can easily select and activate any of the functions clearly identified on the inventive universal remote control device.

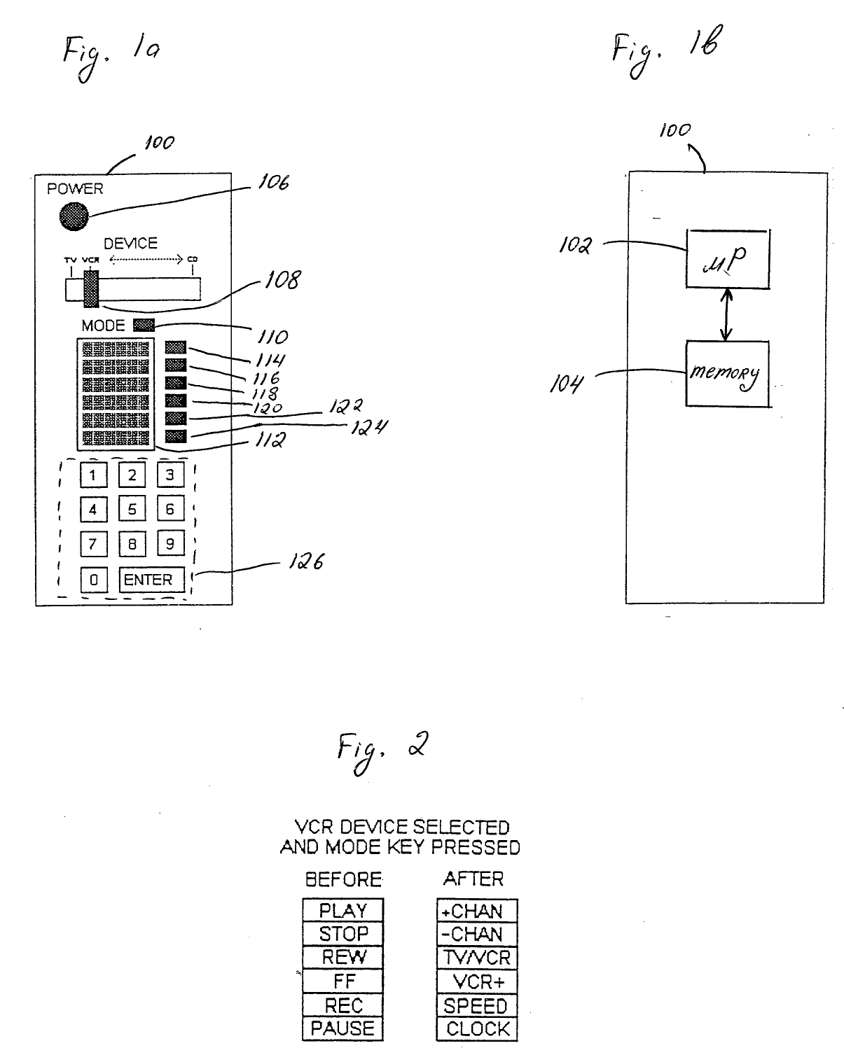

FIGS. 1a and 1b show a block diagram of a universal remote control device 100 in accordance with the present invention. As shown in FIG. 1b, a microprocessor 102 (programmable controller) controls the operation of the device, while a memory 104 stores various data associated with the device and control programs for execution by the microprocessor 102. FIG. 1a illustrates the universal remote control device having a “POWER” switch 106 for turning the device on or off. Further included is a slider switch 108 for selecting A/V components in the system, such as TV, VCR, CD, etc. The universal remote control device 100 also includes a function mode switch 110 for selecting various function modes associated with each A/V component, as will be explained more fully hereinbelow. A display 112 is divided into six individual sections, each having a corresponding activation key 114, 116, 118, 120, 122, 124. As shown in FIG. 1a, each of the display sections is a six alphanumeric character display, wherein each character may be represented by an LED or LCD unit which is backlit for night time use. In addition, the universal remote control device 100 contains a set of channel keys 126 for entering/changing video channels in a television set, for example.

Prior to its operation, the universal remote control device 100 is programmed to recognize each A/V component in the user's system. This is performed in a conventional manner by entering a unique code, for example, a code associated with each A/V component, as well known to those skilled in the art.

Once the identity of all of the A/V components in the system have been programmed into the universal remote control device 100, individual functions pertaining to each A/V component are controlled as follows. Upon power-up, the user selects a component, such as the VCR, for example, by moving the slider switch 108 to an appropriate position, as shown in FIG. 1a. Following the selection of the A/V component, the function mode is defaulted to mode 1 which is the most basic mode. This mode of the VCR includes such basic functions as play, stop, rewind, fast forward, record, and pause, as displayed in the display 112 shown in FIG. 2. Namely, after the user selects the A/V component, the foregoing mode 1 functions are displayed on the display 112 in alignment with the activation keys 114-124. If the user wants to select any of the displayed functions, he activates a respective activation key 114, 116, 118, 120, 122, 124 associated with that function. Continuing, for example, with the representative selection of the VCR as shown in FIG. 2, if the user desires to play a tape in the VCR, he activates activation key 114 (FIG. 1a) to select this desired function. Similarly, any other of the displayed functions can be selected using a corresponding one of the activation keys 116, 118, 120, 122, 124.

If the user desires to perform some other function which is not currently displayed on the display 112, he changes the function mode to the next mode (mode 2, for example) by activating the function mode switch 110. Following the function mode change, the display 112 presents six new functions that are available in the VCR as shown in FIG. 2, for example. As a result, six additional features become available for remote control by the user, such as increasing/decreasing channel, switching between TV and VCR, recording speed, clock, etc. as shown in FIG. 2. As before, each new function is displayed in alignment with a respective activation key; and a desired function can be selected by the corresponding activation key.

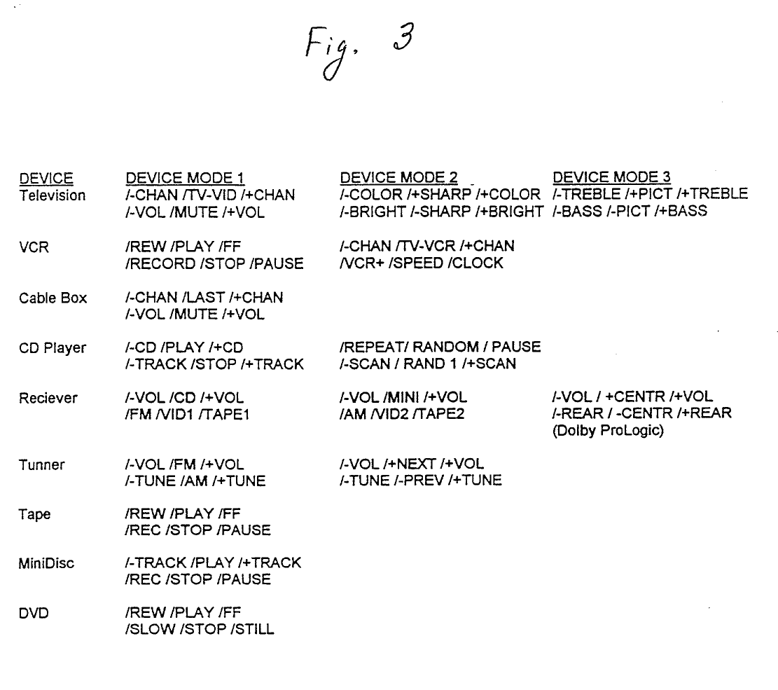

It is understood, of course, that additional functions may be displayed and selected by activating the function mode switch 110 such that still further functions are displayed on the display 112. Hence, as many functions as designed by the manufacturer may be controlled by the universal remote control device 100 according to the present invention. FIG. 3 shows representative function modes (e.g. mode 1, mode 2, mode 3, etc.) and corresponding functions that are available for each mode and that are associated with various A/V components.

In operation, the microprocessor 102 monitors for user input, that is, whether any of the activation or channel keys have been activated. Once the activation of a switch is detected, the microprocessor 102 accesses a preselected portion in the memory 104 for retrieving and displaying a set of functions based on the function mode that has been selected and the slider switch position. Following the retrieval and display of the functions corresponding to the selected function mode, the microprocessor 102 returns to the detection of user input, such as the activation of a respective one of activation keys 114-124.

It is understood that the slider switch 108 for selecting the A/V components in the system may be replaced by other switches, such as a jog shuttle switch, etc. without departing from the spirit of the invention.

Having described specific preferred embodiments of the invention with reference to the accompanying drawings, it is to be understood that the invention is not limited to those precise embodiments, and that various changes and modifications may be effected therein by one skilled in the art without departing from the scope or the spirit of the invention as defined in the appended claims.

What is claimed is:

1. A universal remote control device for wirelessly controlling a number of audio/video devices, comprising:
a switch for selecting one of the audio/video devices;
a memory for storing data defining a plurality of sets of functions performed by respective ones of the audio/video devices;
a programmable controller for accessing from said memory a set of functions corresponding to the audio/video device selected by said switch;
a display for displaying a first subset of said set of functions to be performed by the selected audio/video device; and
a function mode switch for selecting a second subset of said set of functions to be performed by the selected audio/video device.

2. The remote control device according to claim 1, further comprising a number of numeric channel keys for entering channels in the audio/video devices.

3. The remote control device according to claim 1, further comprising a number of activation keys corresponding to said displayed subset of functions for activating respective ones of the displayed functions.

4. The remote control device according to claim 3, wherein the number of activation keys is the same as the number of functions in the displayed subset of functions thereby providing a one-to-one correspondence.
